(19) United States
(12) Patent Application Publication
(10) Pub. No.: US 2026/0057880 A1
(43) Pub. Date: Feb. 26, 2026

(54) FEATURE VECTOR BASED KEYWORD DETECTION IN AUDIO DATA

(71) Applicant: QUALCOMM Incorporated, San Diego, CA (US)

(72) Inventors: Uday Reddy Thummaluri, Nalgonda (IN); Hesu Huang, San Diego, CA (US); Prapulla Vuppu, Secunderabad (IN)

(21) Appl. No.: 18/811,526

(22) Filed: Aug. 21, 2024

(51) Int. Cl. G10L 15/02; G10L 15/05; G10L 15/08; G10L 15/20; G10L 25/06

(52) U.S. Cl. CPC G10L 15/02; G10L 15/05; G10L 15/08; G10L 15/20; G10L 25/06; G10L 2015/088

(57) ABSTRACT

This disclosure provides systems, methods, and devices for audio signal processing that support improved keyword detection for speech recognition applications. In one aspect, a method is provided that includes determining a plurality of correlation measures for a series of consecutive audio data frames. Each measure is calculated by obtaining a first feature vector for a respective audio frame and a second feature vector from a preceding frame, then computing the correlation between them. The method further includes identifying the presence of a spoken keyword, determining its start time based on the correlation measures, and defining buffer data for the keyword. Additional aspects are also provided, such as leveraging models to confirm keyword presence, handling background noise, and utilizing circular buffers for efficient processing. Other aspects and features are also claimed and described.

### TECHNICAL FIELD

Aspects of the present disclosure relate generally to audio signal processing, and more particularly, to improve the detection of spoken keywords in audio data. Some features may enable and provide improved audio signal processing, including improved audio quality.

### INTRODUCTION

Speech recognition technologies may be used in many modern applications, enabling devices to understand and respond to human speech. At its core, speech recognition involves converting spoken language into text or commands using computational algorithms. This process typically includes capturing audio signals with microphones, processing these signals to extract relevant features, and utilizing machine learning models to recognize and interpret the spoken words.

Speech recognition technologies may be used in a variety of applications, from virtual assistants and voice-controlled smart devices to transcription services and accessibility tools. These systems enable users to interact with technology in a natural and intuitive manner, potentially making daily tasks more convenient and efficient. Advancements in speech recognition are expanding its capabilities and opening up new possibilities for innovative applications across different industries.

Keyword detection is often a component of speech recognition systems, especially in applications that require hands-free operation or voice-activated control. This technology involves identifying specific words or phrases, known as keywords, within a continuous stream of audio data. When a keyword is detected, the system may trigger predefined actions, such as activating a digital assistant or executing a command. Keyword detection systems may operate efficiently in real-time, ensuring prompt responses to spoken input.

Machine learning techniques encompass a diverse array of computational methodologies designed to enable systems to learn from and make predictions or decisions based on data. These techniques typically involve the construction of models, algorithms, or neural network architectures that can infer patterns, trends, or structures within large datasets without explicit programming for each task. Machine learning techniques include supervised learning, where models are trained using labeled datasets; unsupervised learning, which involves the identification of patterns in unlabeled data; semi-supervised learning, which combines both labeled and unlabeled data; and reinforcement learning, where models learn optimal behaviors through trial and error interactions with an environment. Machine learning techniques, including neural networks, may be used with speech recognition technologies, such as to identify and interpret speech within audio data.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, the described techniques focus on improving keyword detection and start time estimation in speech recognition systems, particularly in environments with stationary or static background noise. By analyzing the correlation between consecutive audio frames, these techniques aim to accurately identify the start time of a spoken keyword post initial keyword detection. The techniques may include storing and analyzing correlation measures in a circular buffer and using these measures to determine a keyword's start time, thereby enhancing the accuracy and reliability of the overall keyword detection process such as in a multi-stage keyword detection system where keyword data is buffered in the first stage and sent to later stages.

One aspect provides an apparatus, comprising a memory storing processor-readable code and one or more processors coupled to the memory. The one or more processors may be configured to execute the processor-readable code to cause the one or more processors to determine a plurality of correlation measures for a plurality of audio data frames, wherein the plurality of audio data frames contain consecutive portions of audio data. The one or more processors may be configured to execute the processor-readable code, when determining the plurality of correlation measures to, for each respective audio data frame of the plurality of audio data frames: determine a first feature vector for the respective audio data frame; determine a respective correlation measure between the first feature vector and a second feature vector, wherein the second feature vector is determined for a second audio data frame before the respective audio data frame; and add the respective correlation measure to the plurality of correlation measures. The one or more processors may also be configured to determine that the plurality of audio data frames contain a spoken keyword; determine a start time for the spoken keyword within the audio data frames based at least in part on the plurality of correlation measures; and determine buffer data for the spoken keyword based on the start time for the spoken keyword.

Another aspect provides a method, comprising determining a plurality of correlation measures for a plurality of audio data frames, wherein the plurality of audio data frames contain consecutive portions of audio data. Determining the plurality of correlation measures comprises, for each respective audio data frame of the plurality of audio data frames: determining a first feature vector for the respective audio data frame; determining a respective correlation measure between the first feature vector and a second feature vector, wherein the second feature vector is determined for a second audio data frame before the respective audio data frame; and adding the respective correlation measure to the plurality of correlation measures. The method also comprises determining that the plurality of audio data frames contain a spoken keyword; determining a start time for the spoken keyword within the audio data frames based at least in part on the plurality of correlation measures; and determining buffer data for the spoken keyword based on the start time for the spoken keyword.

A further aspect provides a non-transitory computer-readable medium storing instructions that, when executed by at least one processor, cause the at least one processor to determine a plurality of correlation measures for a plurality of audio data frames, wherein the plurality of audio data frames contain consecutive portions of audio data. When determining the plurality of correlation measures, the one or more processors are configured to execute the instructions, for each respective audio data frame of the plurality of audio data frames, to determine a first feature vector for the respective audio data frame; determine a respective correlation measure between the first feature vector and a second feature vector, wherein the second feature vector is determined for a second audio data frame before the respective audio data frame; and add the respective correlation measure to the plurality of correlation measures. The at least one processor is also caused to determine that the plurality of audio data frames contain a spoken keyword; determine a start time for the spoken keyword within the audio data frames based at least in part on the plurality of correlation measures; and determine buffer data for the spoken keyword based on the start time for the spoken keyword.

Methods of audio signal processing described herein may be performed by a signal processing device. The audio signal processing may be applied audio data captured by one or more microphones of the signal processing device. Audio signal processing devices, devices that can playback, record, and/or process one or more audio recordings can be incorporated into a wide variety of devices. By way of example, audio signal processing devices may comprise stand-alone audio devices, such as entertainment devices and personal media players, wireless communication device handsets such as mobile telephones, cellular or satellite radio telephones, personal digital assistants (PDAs), tablets, gaming devices, computing devices such as webcams, video surveillance cameras, or other devices with audio recording or audio capabilities.

The audio signal processing techniques described herein may involve devices having microphones and processing circuitry (e.g., application specific integrated circuits (ASICs), digital signal processors (DSP), graphics processing unit (GPU), or central processing units (CPU)).

In some aspects, a device may include a digital signal processor or a processor (e.g., an application processor) including specific functionality for audio processing. The methods and techniques described herein may be entirely performed by the digital signal processor or the processor, or various operations may be split between the digital signal processor and the processor, and in some aspects split across additional processors. In some embodiments, the methods and techniques disclosed herein may be adapted using input from a neural signal processor (NSP) in which one or more parameters of the signal processing are controlled based on output from a machine learning (ML) model executed by the NSP.

In an additional aspect of the disclosure, a device configured for audio signal processing and/or audio capture is disclosed. The apparatus includes means for recording audio. Example means may include a dynamic microphone, a condenser microphone, a ribbon microphone, a carbon microphone, or a crystal microphone. The microphone may be construed as a microelectromechanical system (MEMS). These components may be controlled to capture first and/or second sound recordings, which may correspond to left and right channels of a recording.

For any of these types of microphones, the microphones may include analog and/or digital microphones. Analog microphones provide a sensor signal, which is some embodiments is conditioned or filtered. Analog microphones in a digital system include an external analog-to-digital converter (ADC) to interface with digital circuitry. Digital microphones include the ADC and other digital elements to convert the sensor signal into a digital data stream, such as a pulse-density modulated (PDM) stream or a pulse-code modulated (PCM) stream.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos (with associated or embedded sounds) in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of a computing device configured for performing signal processing according to one or more aspects of this disclosure.

FIG. 2 is a block diagram of a computing device configured for audio signal processing and speech recognition in a multimedia device according to one or more aspects of the disclosure.

FIG. 3 is a block diagram of a system for detecting spoken keywords within audio data according to one aspect of the present disclosure.

FIG. 4 is a timing diagram of an audio signal showing keyword detection start times according to one aspect of the present disclosure.

FIG. 5 is a flowchart of a method for detecting spoken keywords within audio data according to one aspect of the present disclosure.

FIGS. 6-8 are flowcharts of methods for determining keyword detection start times according to aspects of the present disclosure.

Like reference numbers and designations in the various drawings indicate like elements.

### DETAILED DESCRIPTION

The present disclosure provides systems, apparatus, methods, and computer-readable media that support signal processing, including techniques for spoken keyword detection in audio signals.

Traditional keyword detection in speech recognition systems may typically involve a multi-stage process (such as a two-stage process). The first stage may use a detector or other mechanism to initially recognize whether a keyword has been spoken. Following detection, a keyword start time estimation process may identify the start time of the keyword. The detected keyword may then be further processed, such as to verify that the keyword was actually spoken.

Such techniques often face significant challenges in accurately determining the true start and end points of the keyword. For instance, for slow talkers or considerably longer keywords (with multiple syllables), keywords might span up to 2.5 seconds or more. In such cases, the current techniques perform poorly in start time estimation resulting in significant deviations from the actual start times. These inaccuracies may necessitate additional buffering, which may not always be sufficient to capture the complete keyword, causing reliability issues in the speech recognition process.

Consequently, extra audio buffers may be included before and after the estimated indices to ensure the entire keyword is captured for further processing. Additionally, essential audio data required for the further processing may be unintentionally omitted if the start or end times are incorrectly detected. This may result in inaccurate keyword detections (such as through false negatives in downstream verification) and may result in the utilization of additional computing resources (such as to process additional, unnecessary audio data).

One solution to this problem may be to analyze the correlation between consecutive audio frames to more accurately determine the start time of a keyword in stationary or static background noise scenarios. Specifically, the present techniques involve computing feature vectors for each audio frame and determining a correlation measure, such as cosine similarity, between consecutive frames. These correlation measures may be stored in a circular buffer, which is dynamically updated as new frames are processed. Upon initial keyword detection, these techniques examine the correlation measures to determine a more accurate start time estimation, such as by identifying where significant decreases occur, indicating the start of the keyword.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

Particular implementations of the subject matter described in this disclosure may be implemented to realize one or more of the following potential advantages or benefits. In some aspects, the present disclosure provides techniques for audio signal processing that may be particularly beneficial accurate keyword start time estimation. For example, by using feature vector correlations and storing these measures in a circular buffer, the described techniques may significantly reduce the deviation from the actual keyword start time, thus ensuring more accurate and reliable keyword detection. This approach may also minimize latency, as it allows for real-time processing and immediate analysis post keyword detection. Furthermore, these techniques may reduce the need for additional audio data buffers, which can reduce computing resources required for keyword detection and may improve detection times for keywords. For end users, these techniques may result in more responsive and reliable voice-activated systems, reducing the occurrence of missed or partially detected keywords. Additionally, these techniques may enhance the overall performance of speech recognition systems, especially in stationary or static noise environments, by ensuring that keywords are accurately identified and buffered for further processing. Furthermore, by reducing computing resource utilization, these techniques may improve battery life on devices configured to perform speech recognition.

The detailed description set forth below, in connection with the appended drawings to which the text references, is intended as a description of various embodiments and is not intended to limit the scope of the disclosure. Rather, the detailed description includes specific details for the purpose of providing a thorough understanding of the subject matter of this disclosure. It will be apparent to those skilled in the art that these specific details are not required in every case and that, in some instances, well-known structures and components are shown in block diagram form for clarity of presentation.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device for recording sounds and/or processing sound signals using one or more microphones, such as a MEMS microphone, may include a configuration of one, two, three, four, or more microphones at different locations on the device. The example device may include one or more digital signal processors (DSPs), AI engines, or other suitable circuitry for processing signals captured by the microphones. The one or more digital signal processors (DSPs) may output signals representing sounds through a bus for storage in a memory, for reproduction by an audio system, and/or for further processing by other components (such as an applications processor). The processing circuitry may perform further processing, such as for encoding, storage, transmission, or other manipulation of the audio signals. In some embodiments, the example device may include audio circuitry including an audio amplifier (e.g., a class-D amplifier) for driving a transducer to reproduce the sounds represented by the audio signals. A speaker may be integrated with the device and coupled to the audio amplifier to be driven by the audio amplifier for reproducing the sounds. A connection may be provided by a jack or other connector on the device to couple an external transducer (e.g., an external speaker or headphones) to the audio amplifier to be driven by the audio circuitry to reproducing the sounds. In some embodiments, the jack may instead output a digital signal for conversion and amplification by an external device, such as when the jack is configured to be coupled to a digital device through a Universal Serial Bus (USB) Type-C (USB-C) connection and some or all of the audio circuitry is bypassed.

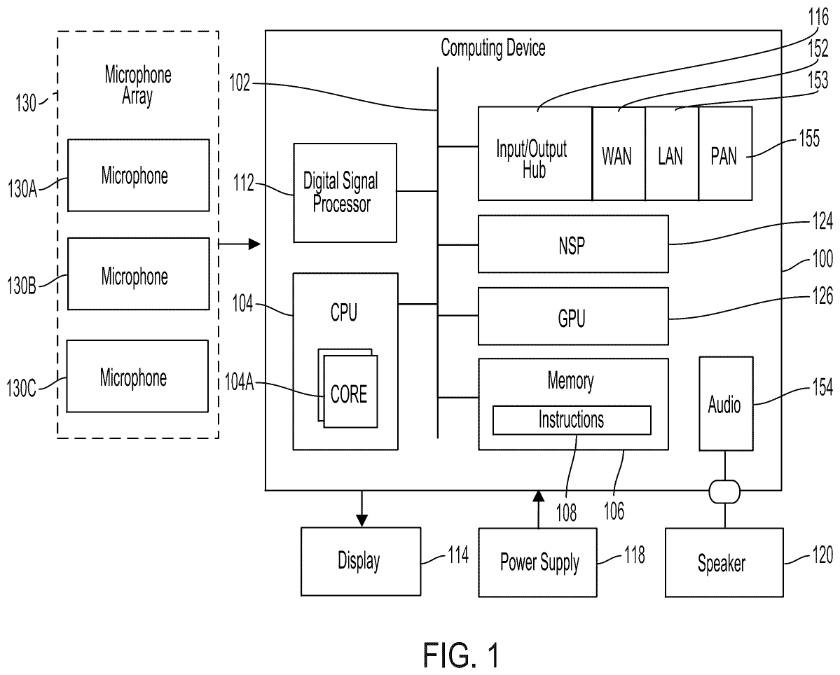

FIG. 1 shows a block diagram of a computing device 100 configured for performing signal processing according to one or more aspects of this disclosure. The computing device 100 may include several components coupled together through a bus 102, which may be a network-on-a-chip (NoC) or a plurality of NOCs interconnecting various components. For example, although FIG. 1 illustrates several components coupled to the bus 102, the several components may be coupled to different busses with additional busses connecting the different busses to provide a path for communication between the components.

One example component in the computing device 100 is a digital signal processor 112 for signal processing. The DSP 112 may process audio signals received from microphones 130A, 130B, and 130C of microphone array 130. The DSP 112 may include hardware customized for performing a limited set of operations on specific kinds of data. For example, a DSP may include transistors coupled together to perform operations on streaming data and use memory architectures and/or access techniques to fetch multiple data or instructions concurrently. Such configurations may allow the DSP 112 to operate on real-time data, such as video data, audio data, or modem data, in a power-efficient manner.

The computing device 100 also includes a central processing unit (CPU) 104 and a memory 106 storing instructions 108 (e.g., a memory storing processor-readable code or a non-transitory computer-readable medium storing instructions) that may be executed by a processor of the computing device 100. The CPU 104 may be a single central processing unit (CPU) or a CPU cluster comprising two or more cores such as core 104A. The CPU 104 may include hardware capable of performing generic operations on many kinds of data, such as hardware capable of executing instructions from the Advanced RISC Machines (ARM®) instruction set, such as ARMv8 and ARMv9. For example, a CPU 104 may include transistors coupled together to perform operations for supporting executing an operating system and user applications (e.g., a camera application, a multimedia application, a gaming application, a productivity application, a messaging application, a videocall application, an audio recording application, a video recording application). The CPU 104 may execute instructions 108 retrieved from the memory 106. In some embodiments, the CPU 104 executing an operating system may coordinate execution of instructions by various components within the computing device 100. For example, the CPU 104 may retrieve instructions 108 from memory 106 and execute the instructions on the DSP 112.

The computing device 100 may further include a neural signal processor (NSP) 124 for executing machine learning (ML) models relating to multimedia applications. The NSP 124 may include hardware configured to perform and accelerate convolution operations involved in executing machine learning algorithms. For example, the NSP 124 may improve performance when executing predictive models such as artificial neural networks (ANNs) (including multilayer feedforward neural networks (MLFFNN), the recurrent neural networks (RNN), and/or the radial basis functions (RBF)). The ANN executed by the NSP 124 may access predefined training weights stored in the memory 106 for performing operations on user data.

The computing device 100 may be coupled to a display 114 for interacting with a user. The computing device 100 may also include a graphics processing unit (GPU) 126 for rendering images on the display 114. In some embodiments, the CPU 104 may perform rendering to the display 114 without a GPU 126. In some embodiments, the GPU 126 may be configured to execute instructions for performing operations unrelated to rendering images, such as for processing large volumes of datasets in parallel.

Processing algorithms, techniques, and methods that are described herein may be executed by at least one processor of the computing device 100, which may include execution by all steps on one of the processors (e.g., DSP 112, CPU 104, NSP 124, GPU 126) or may include execution of steps across a combination of one or more of the processors (e.g., DSP 112, CPU 104, NSP 124, GPU 126). In some embodiments, at least one of the DSP 112 or the CPU 104 executes instructions to perform various operations described herein, including speech recognition, such as keyword recognition. For example, execution of the instructions by the CPU 104 as part of a multimedia application (e.g., a voice recorder, a sound recording, or a video recorder) may instruct the DSP 112 to begin or end capturing audio from one or more microphones 130A-C. The operations of the CPU 104 may be based on user input. For example, a voice recorder application executing on processor 104 may receive a user command to begin a voice recording upon which audio comprising one or more channels is captured and processed for playback and/or storage. Audio processing to determine “output” or “corrected” signals, such as according to techniques described herein, may be applied to one or more segments of audio in the recording sequence.

Input/output components may be coupled to the computing device 100 through an input/output (I/O) hub 116. An example of a hub 116 is an interconnect to a peripheral component interconnect express (PCIe) bus. Example components coupled to hub 116 may be components used for interacting with a user, such as a touch screen interface and/or physical buttons. Some components coupled to hub 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 155). A WAN adaptor 152 may be a 4G LTE or a 5G NR wireless network adaptor. A LAN adaptor 153 may be an IEEE 802.11 WiFi wireless network adapter. A PAN adaptor 155 may be a Bluetooth wireless network adaptor. Each of the WAN adaptor 152, LAN adaptor 153, and/or PAN adaptor 155 may be coupled to an antenna that may be shared by each of the adaptors 152, 153, 155, or coupled to multiple antennas configured for primary and diversity reception and/or configured for receiving specific frequency bands. In some embodiments, the WAN adaptor 152, LAN adaptor 153, and/or PAN adaptor 155 may share circuitry, such as portions of a radio frequency front end (RFFE).

Audio circuitry 154 may be integrated in the computing device 100 as dedicated circuitry for coupling the computing device 100 to a speaker 120. The speaker 120 may be external to the computing device 100 or internal to the computing device 100. The speaker 120 may be a transducer such as a speaker (either internal to or external to a device incorporating the computing device 100) or headphones. The audio circuitry 154 may include coder/decoder (CODEC) functionality for processing digital audio signals. The audio circuitry 154 may further include one or more amplifiers (e.g., a class-D amplifier) for driving a transducer coupled to the computing device 100 for outputting sounds generated during execution of applications by the computing device 100. Functionality related to audio signals described herein may be performed by a combination of the audio circuitry 154 and/or other processors of the computing device 100 (e.g., CPU 104, DSP 112, GPU 126, NSP 124).

The computing device 100 may couple to external devices outside the package of the computing device 100. For example, the computing device 100 may be coupled to a power supply 118, such as a battery or an adaptor to couple the computing device 100 to an energy source. The signal processing described herein may be adapted to and achieve power efficiency to support operation of the computing device 100 from a limited-capacity power supply 118 such as a battery. For example, operations may be performed on a portion of the computing device 100 configured for performing the operation at a lowest power consumption. As another example, operations themselves are performed in a manner that reduces an amount of computations to perform the operation, such that the algorithm is optimized for extending the operational time of a device while powered by a limited-capacity power supply 118. In some embodiments, the operations described herein may be configured based on a type of power supply 118 providing energy to the computing device 100. For example, a first set of operations may be executed to perform a function when the power supply 118 is a wall adaptor. As another example, a second set of operations may be executed to perform a function when the power supply 118 is a battery.

The computing device 100 may also include or be coupled to additional features or components that are not shown in FIG. 1. Although components are shown integrated as a single computing device 100, which may include all components built on a single semiconductor die with a common semiconductor substrate, other arrangements of the illustrated blocks different number of dies, substrates, and/or packages may be arranged to accomplish the same functionality described in this disclosure.

The memory 106 may include a non-transient or non-transitory computer readable medium storing computer-executable instructions as instructions 108 to perform all or a portion of one or more operations described in this disclosure. The instructions 108 may include a multimedia application (or other suitable application such as a messaging application) to be executed by the computing device 100 that records, processes, or outputs audio signals. The instructions 108 may also include other applications or programs executed by the computing device 100, such as an operating system and applications other than for multimedia processing.

In addition to instructions 108, the memory 106 may also store audio data. The computing device 100 may be coupled to an external memory and configured to access the memory for writing output audio files for later playback or long-term storage. For example, the computing device 100 may be coupled to a flash storage device comprising NAND memory for storing video files (e.g., MP4-container formatted files) including audio tracks and/or storing audio recordings (e.g., MPEG-1 Layer 3 files, also referred to as MP3 files). Portions of the video or audio files may be transferred to memory 106 for processing by the computing device 100, with the resulting signals after processing encoded as video or audio files in the memory 106 for transfer to the long-term storage.

While the computing device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

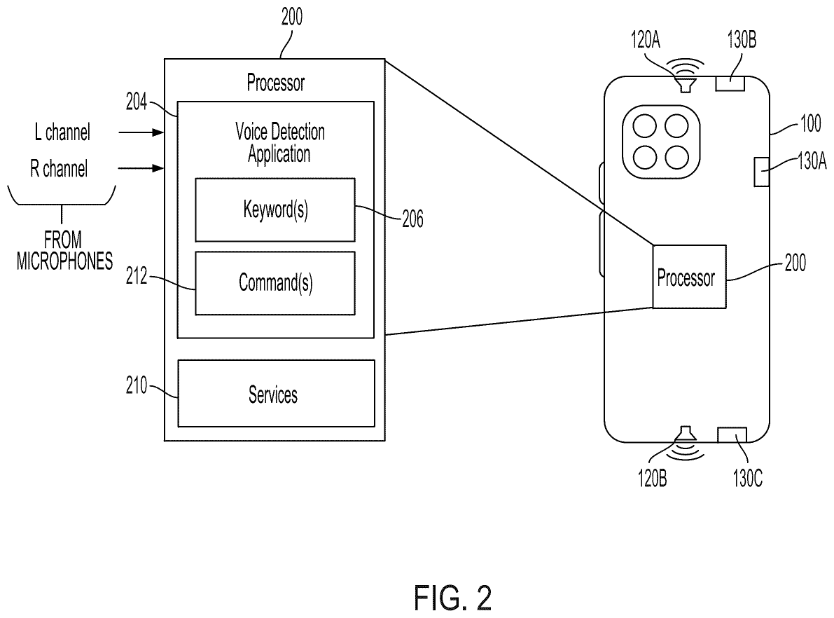

The computing device of FIG. 1 may be operated to obtain improved keyword detection start time estimation and/or improved user experience through more accurate keyword detection by applying feature vector-based keyword start estimation technique. For example, FIG. 2 is a block diagram of a computing device configured for audio signal processing and speech recognition in a multimedia device according to one or more aspects of the disclosure. Processor 200 of the computing device 100 may execute a voice detection application 204, such as part of an operating system or driver, to provide speech recognition services, such as keyword detection. In particular, processor 200 may control the capture of audio data from microphones or other audio sources and/or to control the configuration of audio processing circuitry 154. The audio data may then be analyzed and/or processed by the voice detection application 204 to detect one or more keywords 206 and/or commands 212. For example, keywords 206 may indicate that a user intends to activate the voice detection application and commands 212 may indicate operations to be performed by the voice detection application 204, the computing device 100, or another computing device. For example, the commands 212 may interface with one or more other services (e.g., computing services) of the processor 200.

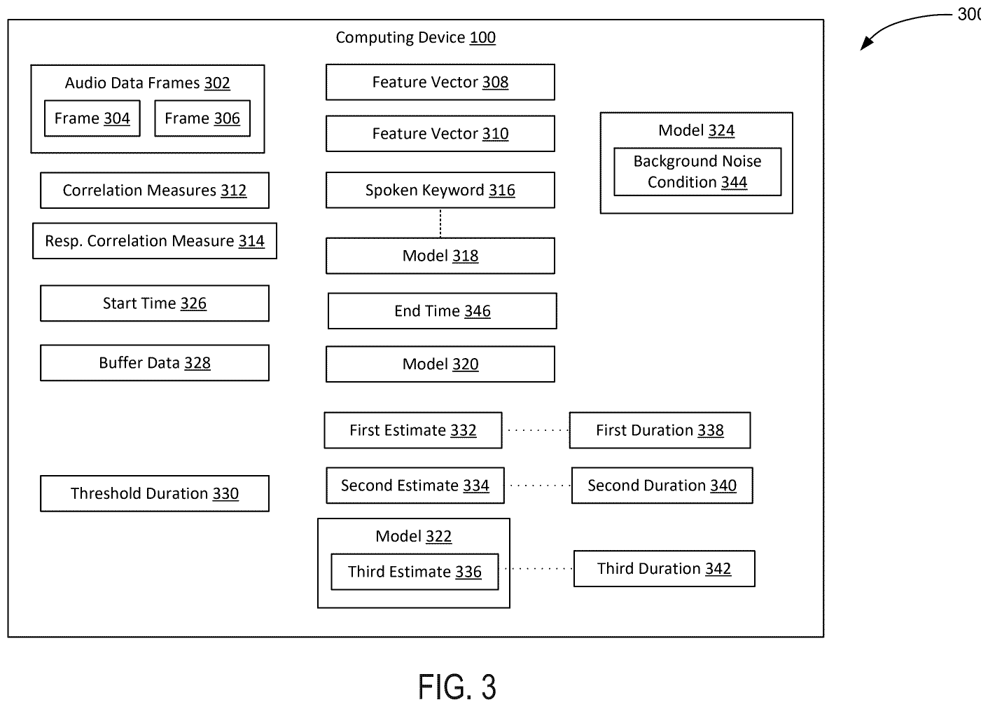

FIG. 3 depicts a system 300 for detecting spoken keywords within audio data according to one aspect of the present disclosure. The system 300 includes a computing device 100. The computing device 100 includes audio data frames 302, correlation measures 312, a first feature vector 308, a second feature vector 310, a respective correlation measure 314, a spoken keyword 316, a first model 318, a start time 326, an end time 346, buffer data 328, a second model 320, a threshold duration 330, a first estimate 332, a first duration 338, a second estimate 334, a second duration 340, a third model 322, a third duration 342, and a fourth model 324. The audio data frames 302 includes a second audio data frame 304, a respective audio data frame 306. The first model 318 includes an end time 346, the third model 322 includes a third estimate 336, and the fourth model 324 includes a background noise condition 344.

The computing device 100 may be configured to determine a plurality of correlation measures 312 for a plurality of audio data frames 302. In certain implementations, the plurality of audio data frames 302 contain consecutive portions of audio data. In certain implementations, the audio data frames 302 may contain consecutive portions of the audio data. For example, each frame may represent 10 ms of audio captured sequentially. In certain implementations, the audio data frames 302 may not overlap with one another. For example, a first frame may cover 0-10 ms of audio data and a second frame may cover 10-20 ms of audio data. In additional or alternative implementations, the audio data frames may at least overlap with one another. For example, a first frame may cover 0-10 ms of audio data and a second frame may overlap and cover 5-15 ms of the audio data. In certain implementations, the audio data frames 302 may have a predetermined length. For example, each audio data frame may be fixed at a length of 5 ms, 10 ms, 15 ms, 20 ms, and the like.

The computing device 100 may be configured, for each respective audio data frame 306 of the plurality of audio data frames 302, to determine a first feature vector 308 for the respective audio data frame 306. In certain implementations, features may be determined for the audio frames and may be stored in corresponding feature vectors 308, 310. The feature vectors 308, 310 may be single-dimensional, such as an N×1 vector, where N may be the number of features. In additional or alternative implementations, feature vectors 308, 310 may be multi-dimensional, such as an N×M×O vector, where at least two of N, M, and O are greater than 1. Feature vectors 308, 310 for audio data may include numerical representations of various aspects of an audio frame. Some examples of audio features include spectral components, temporal dynamics, and cepstral coefficients. Spectral components may be determined to quantify the distribution of frequencies in an audio frame, while temporal dynamics may capture changes over time, such as onset or decay rates of different sounds. Cepstral coefficients, such as MFCC (Mel-Frequency Cepstral Coefficients), may be determined to represent the rate of change in the different spectrum bands. Mel-scaled spectral coefficients (MEL) emphasize frequencies in a way that approximates the human ear's response. Per-Channel Energy Normalization (PCEN) may normalize the energy on a per-channel basis. In certain implementations, the first feature vector 308 may include an MEL for the respective audio data frame 306, an MFCC for the respective audio data frame 306, a PCEN for the respective audio data frame 306, or a combination thereof.

The computing device 100 may be configured, for each respective audio data frame 306 of the plurality of audio data frames 302, to determine a respective correlation measure 314 between the first feature vector 308 and a second feature vector 310, the second feature vector 310 may be determined for a second audio data frame 304 before the first portion of the audio data. In certain implementations, the first audio data frame may be the next consecutive audio data frame after the second audio data frame 304. In certain implementations, the correlation measures 312 may include metrics determined to quantify the degree of similarity or relationship between two feature vectors 308, 310. Example correlation measures 312 may include cosine similarity, which evaluates the cosine of the angle between two vectors, providing a measure of orientation similarity irrespective of magnitude; Euclidean distance, which calculates the straight-line distance between two vectors in a multi-dimensional space; and Pearson correlation, which measures the linear relationship between two vectors. Other correlation measures 312 may include Manhattan distance, Jaccard index, and the like. In certain implementations, the respective correlation measure 314 may be determined as a cosine similarity between the first feature vector 308 and the second feature vector 310.

The computing device 100 may be configured, for each respective audio data frame 306 of the plurality of audio data frames 302, to add the respective correlation measure 314 to the plurality of correlation measures 312. In certain implementations, the audio data frames 302 may be received and processed to determine the feature vectors 308, 310 on a continuous basis. For example, each audio data frame 302 may be processed sequentially as it is captured and/or received by the computing device 100. In certain implementations, the plurality of correlation measures 312 are stored in a circular buffer. In such instances, adding the respective correlation measure 314 may include removing an oldest correlation measure from the plurality of correlation measures 312.

The computing device 100 may be configured to determine that the plurality of audio data frames 302 contain a spoken keyword 316. In certain implementations, the spoken keyword 316 may be a specific word or phrase that is predefined and recognized by the system to trigger a certain action. For example, the spoken keyword may be a wake word like “Hey Assistant”, “Hello Device”, “Activate System,” and the like. Such spoken keywords 316 may trigger a response or activates a specific function within the device upon detection (such as one or more services 210). In certain implementations, determining that the audio data contains a spoken word may include providing the plurality of audio data frames 302 to a first model 318, the first model 318 may be configured to determine that the audio data contains a spoken keyword 316.

The computing device 100 may be configured to determine a start time 326 for the spoken keyword 316 within the audio data frames 302 based at least in part on the plurality of correlation measures 312. In certain implementations, determining the start time 326 for the spoken keyword 316 may include determining a change in the plurality of correlation measures 312 and determining a first estimate 332 of the start time 326 based on a time of the change (such as a timestamp or audio data frame corresponding to the change). In certain implementations, the change may include a decrease between two or more sequential correlation measures 312 within the plurality of correlation measures 312. In certain implementations, the change may refer to a decrease or increase in correlation measures 312 between sequential audio data frames 304, 306, indicating the onset of a user speaking. For example, a decrease in cosine similarity values between consecutive feature vectors could signify the beginning of speech after a period of background noise and may accordingly indicate a potential start time 326 for a spoken keyword 316. The computing device 100 may detect the change using one or more thresholds. For example, if the correlation measure decreases below a threshold (such as below a correlation measure of 0.7) or changes by more than a predetermined amount (such as a change in correlation measure of 0.2 or more) over a series of frames a change may be detected. The device may further employ a consistency check, where multiple consecutive decreases in the correlation measure are required to confirm the change. For example, the start time 326 might be determined if there is a continuous decrease in correlation over a span of 10-20 audio frames.

The computing device 100 may be configured to determine buffer data 328 for the spoken keyword 316 based on the start time 326 for the spoken keyword 316. The computing device 100 may be configured to determine an end time 346 for the spoken keyword 316. In such implementations, the buffer data 328 may include audio data captured between the start time 326 and the end time 346. In certain implementations, the buffer data 328 may further include one or more additional data frames captured before the start time 326. The additional data frames may include audio data frames that occur before the estimated start time 326 of the spoken keyword 316. For example, the system might consider 5, 10, 20, and the like additional data frames preceding the start time 326. The additional data frames may account for and correct potential delays or inaccuracies in the start time estimation process, thus increasing the likelihood that the entire keyword is captured in the buffer data 328.

To determine the end time 346, the first model 318 may be further configured to determine an end time 346 for the spoken keyword 316 based on the plurality of audio data frames 302. In additional or alternative implementations, the end time 346 may be determined as the most current audio data frame. For example, if the keyword detection and analysis of audio data frames 302 is performed on a continuous basis, the computing device 100 may determine the end time 346 as the time corresponding to the current audio data frame. Alternatively, the end time 346 may be set as the most current audio data frame at the moment the keyword was detected, ensuring that the keyword segment is captured accurately.

In certain implementations, the buffer data 328 may be used to verify detection of the spoken keyword 316. For example, the computing device may provide the buffer data 328 to a second model 320 to verify detection of the spoken keyword 316. The second model 320 may be configured to receive the buffer data 328 and determine whether the buffer data 328 contains the spoken keyword 316.

The computing device 100 may be configured to determine the start time 326 by determining a first duration 338 based on the first estimate 332, determining that the first duration 338 satisfies a threshold duration 330, and determining the start time 326 based on the first estimate 332 of the start time 326. In certain implementations, the first duration 338 may be determined as the duration from the first estimate 332 of the start time 326 to a most recent audio data frame of the plurality of audio data frames 302. In additional or alternative implementations, the first duration 338 may be calculated from the first estimate 332 of the start time 326 to the most recent audio data frame available when the spoken keyword 316 was initially detected. In certain implementations, the start time 326 may be determined directly as the first estimate 332 of the start time 326. Additionally or alternatively, the start time 326 may be adjusted to incorporate one or more additional audio data frames 302 preceding the first estimate 332. In certain implementations, determining that the first duration 338 satisfies a threshold duration 330 may include determining that the first duration 338 is greater than or equal to 500 ms. In alternative implementations, the computing device 100 may be configured to utilize a different threshold duration or durations. For example, the threshold duration 330 may be configured as 300 ms, 450 ms, 600 ms, 750 ms, and the like. In certain implementations, the threshold duration 330 may be determined based on the length of the spoken keyword 316.

If the computing device 100 determines that the first duration 338 does not satisfy a threshold duration 330, the computing device 100 may be configured to determine the start time 326 based on a predetermined duration for the spoken keyword 316. In certain implementations, the predetermined duration may be a fixed interval associated with particular spoken keywords 316. For example, the fixed duration could be 2 seconds for a specific keyword. In alternative implementations, other durations may be set to align with the expected length of various keywords and the requirements of the application, such as 1 second, 1.5 seconds, 2.5 seconds, 3 seconds, 5 seconds, and the like.

The computing device 100 may be configured to determine multiple estimates of the start time 326. For example, in certain implementations the computing device 100 may be configured to determine a second estimate 334 of the start time 326 before determining the first estimate 332. The second estimate 334 may be determined with a machine learning model, such as the second model 320. For example, the second model 320 may be trained to receive a sequence of audio data frames 302 and determine start time estimates for the detected spoken keyword 316. Accordingly, the model 320 may be configured to enhance the capabilities of the model 318, with the model 318 tuned to accurate detection of the spoken keyword and the model 320 configured to more accurately determine estimates 334 of the start time 326 after the keyword 316 has been detected. Such a combination of models 318, 320 may thus significantly improve the precision of keyword detection start times, especially in environments with varying noise conditions.

In certain implementations, the computing device 100 may be configured to determine a second duration 340 based on the second estimate 334. For example, the second duration 340 may be determined as the duration from the second estimate 334 of the start time 326 to a most recent audio data frame of the plurality of audio data frames 302. In additional or alternative implementations, the first duration 338 may be calculated from the first estimate 332 of the start time 326 to the most recent audio data frame available at the moment the spoken keyword 316 was initially detected. In certain implementations, the computing device 100 may be configured to compare the second duration 340 to the threshold duration 330. If the computing device 100 determines that the second duration 340 is greater than or equal to the first duration 338, the computing device 100 may be configured to determine the start time 326 based on the second estimate 334. If the computing device 100 determines that the second duration 340 is less than the first duration 338, the computing device 100 may be configured to determine the start time 326 based on the first estimate 332. In particular, the computing device 100 may be configured to determine the first estimate 332 in response to determining that the second duration 340 is less than the first duration 338 and may not determine the first estimate 332 otherwise.

The computing device 100 may be configured to determine the start time 326 in accordance with background noise conditions for the audio data. For example, the first model 318 may require stationary or static background noise, where the audio background remains consistent over time. In additional or alternative implementations, the accuracy of these techniques may be dependent on the signal-to-noise ratio (SNR) of the audio captured, with higher SNR levels generally facilitating more accurate detection and processing of the spoken keyword 316. In certain implementations, the computing device 100 may be configured to determine a background noise condition 344 for the audio data. In certain implementations, the background noise condition 344 may be determined to indicate a type of background noise, a level of background noise, or a combination thereof for the audio data captured in the audio data frames 302. The background noise may include ambient noise or other noise that does not correspond to spoken words (or suspected spoken words) from a user of the computing device 100. In certain implementations, the background noise condition 344 may generally indicate a type of background noise, such as Loud Events, Scenes, or Ambient. In additional or alternative implementations, the background noise condition 344 may indicate specific types of background noises. For example, specific sound events may be identified, such as a dog barking, a baby crying, a doorbell ringing, a car honking, keyboard typing, and the like. As another example, different environments, or scenes, may be identified, such as being indoors, outdoors, in a home, in an office, on the street, in a car, in a busy market, and the like. As a further example, specific types of ambient noises may be identified, such as silence, speech, low-level noise, music playing, wind noise, crowd murmuring, and the like. Furthermore, background noise conditions may also include specific scenarios like construction noise from machinery, drilling, or hammering; nature sounds such as rain, thunderstorms, birds chirping, or waves crashing; electronic noise like the background hum from appliances or electronic devices; and transportation sounds including noises from airplanes, trains, buses, or motorcycles. In certain implementations, the computing device 100 may be configured to determine the background noise condition 344 in response to determining that the first duration 338 does not satisfy the threshold duration 330.

In certain implementations, the background noise condition 344 for the audio data may be determined by a fourth machine learning model 324. For example, the background noise condition 344 may be determined by a machine learning model trained to identify and classify various types of background noise. One such model may be referred to as an Audio Context Detector (ACD), and may be configured to continuously analyzing incoming audio data frames to determine prevailing noise conditions. In certain implementations, the model 324 may receive feature vectors 308, 310 for the audio data frames. In additional or alternative implementations, the model 324 may be configured to determine separate feature vectors for received audio data. In response, the model 324 may determine and output the background noise condition 344 for the audio data, such as one or more of the conditions described above. In certain implementations, the model 324 may receive and analyze additional data beyond the plurality of audio data frames 302, and may maintain its own buffer of audio data that is longer. In certain implementations, the model 324 may be configured to continuously receive audio data and determine real-time background noise conditions 344. In additional or alternative implementations, the computing device 100 may provide audio data to the model 324 as needed to determine the background noise condition 344.

In certain implementations, the computing device 100 may determine whether the background noise condition 344 satisfies a first condition. In certain implementations, the first condition may specify a particular type or category of background noise for the audio data. For example, the first condition may specify that the background noise condition 344 indicates ambient background noise within the audio data (such as the “Ambient” category, or a particular type of noise that is classified as ambient). Other implementations may specify other types of noise conditions, including other types of background noise. Additionally or alternatively, the background noise condition may be specified and compared using different techniques. For example, threshold levels of background audio noise may be specified by the first condition instead of (or in addition to) specifying particular types of categories of noise. Examples threshold may include setting a decibel (dB) level threshold where the background noise must be less than a specified dB value to indicate a quiet condition, consistency of noise levels over time, filters to distinguish between transient noises and sustained background noise, and the like.

If the computing device 100 determines that the background noise condition satisfies the first condition, the computing device 100 may determine the first estimate 332 of the start time 326. If the computing device determines that the background noise condition 344 does not satisfy the first condition, the computing device may be configured to determining a third estimate 336 of the start time 326 using a third model 322. In certain implementations, the third model 322 may be implemented as a Deep Neural Network Voice Activity Detection (DNNVAD) and may be trained to distinguish between speech and non-speech segments within audio data. In particular, the model 322 may be implemented as a deep learning neural network trained to analyze temporal and spectral features of audio signals to predict whether corresponding audio frames contain speech data and thereby determine when speech begins within the audio signal. In certain implementations, the model 322 may be dynamically adjusted based on the noise conditions. For example, in environments with high background noise, the model's sensitivity may be increased to ensure reliable keyword detection. In certain implementations, the model 324 may receive feature vectors 308, 310 for the audio data frames. In additional or alternative implementations, the model 324 may be configured to determine separate feature vectors for received audio data. In response, the model 324 may determine and output the background noise condition 344 for the audio data, such as one or more of the conditions described above. In certain implementations, the model 324 may receive and analyze additional data beyond the plurality of audio data frames 302, and may maintain its own buffer of audio data that is longer. In certain implementations, the model 324 may be configured to continuously receive audio data and determine real-time background noise conditions 344. In additional or alternative implementations, the computing device 100 may provide audio data to the model 324 as needed to determine the background noise condition 344. In additional or alternative implementations, the computing device 100 may be configured to use predetermined duration for the spoken keyword 316 in response to determining that the background noise condition 344 is not satisfied. For example, a fixed duration of 1 second, 1.5 second 2 seconds, 2.5 seconds, and the like (as discussed above) may be used. Such implementation may ensure the entire keyword is captured accurately even when the background noise creates uncertainties.

For example, the models 318, 320, 322, 324 may be implemented as one or more machine learning models, including supervised learning models, unsupervised learning models, other types of machine learning models, and/or other types of predictive models. For example, the models 318, 320, 322, 324 may be implemented as one or more of a neural network, a transformer model, a decision tree model, a support vector machine, a Bayesian network, a classifier model, a regression model, and the like. The models 318, 320, 322, 324 may be trained based on training data to perform the functions described above. For example, one or more training datasets may be used to train each of the models 318, 320, 322, 324. The training data sets may specify one or more expected outputs. Parameters of the models 318, 320, 322, 324 may be updated based on whether the models 318, 320, 322, 324 generates correct outputs when compared to the expected outputs. In particular, the models 318, 320, 322, 324 may receive one or more pieces of input data from the training data sets that are associated with a plurality of expected outputs. The models 318, 320, 322, 324 may generate predicted outputs based on a current configuration of the models 318, 320, 322, 324. The predicted outputs may be compared to the expected outputs and one or more parameter updates may be computed based on differences between the predicted outputs and the expected outputs. In particular, the parameters may include weights (e.g., priorities) for different features and combinations of features. The parameter updates the models 318, 320, 322, 324 may include updating one or more of the features analyzed and/or the weights assigned to different features or combinations of features (e.g., relative to the current configuration of the models 318, 320, 322, 324).

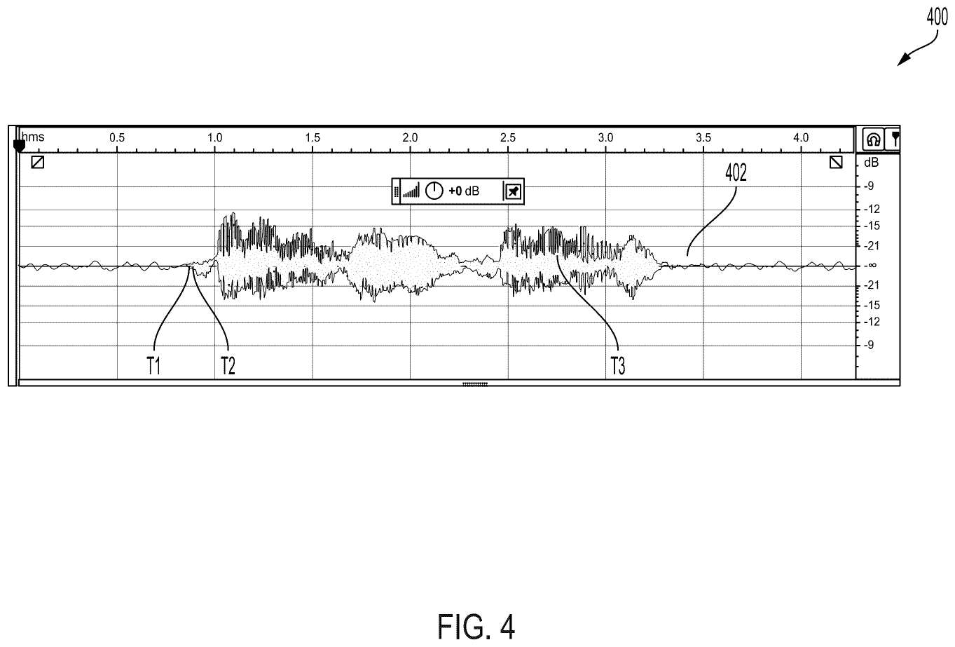

The proposed techniques may result in the improved determination of when spoken keywords are detected within received audio data. In particular, FIG. 4 shows a timing diagram 400 of an audio signal 402 over time according to one aspect of the present disclosure. In particular, the diagram 400 shows the audio signal 402 over an approximately 4 second period in which a spoken keyword is received. The audio signal 402 shows relatively low background noise before and after a spoken keyword is received. The spoken keyword begins at T1, which is about 0.87 seconds after the beginning of the audio signal 402. The spoken keyword may have been spoken slowly, resulting in an inaccurate detection of the starting time T3 using prior techniques. In particular, existing techniques resulted in a determined start time T3 of 2.76 seconds. T3 is almost two full seconds after the start of the spoken keyword. As a result, any buffer data selected based on T3 is likely to exclude much of the spoken keyword. Accordingly, when the buffer data is used to verify detection of the spoken keyword, verification is likely to fail and falsely indicate that the spoken keyword was not detected. By contrast, using the above-described techniques, a start time T2 was estimated at T2, which is about 0.83 after the beginning of the audio signal 402. This is considerably closer to the actual start time of 0.87 seconds and is much more likely to result in accurate verification of the spoken keyword.

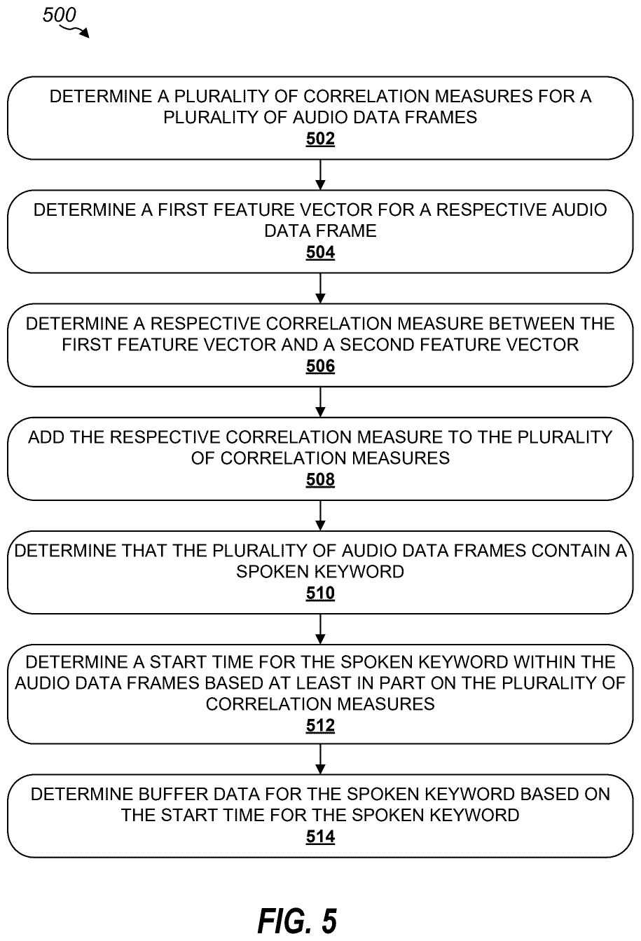

FIG. 5 shows a flow chart of an example method 500 for detecting spoken keywords within received audio data according to one or more aspects of this disclosure. The operations of the method 500 may result in improved detection of keywords and improved determination of start times for spoken keywords within received audio data, which results in an improved user experience and reduced utilization of computing resources. Each of the operations described with reference to FIG. 5 and the method 500 may be performed by the computing device 100, such as one or a combination of processors of the computing device 100.

The method 500 includes determining a plurality of correlation measures for a plurality of audio data frames (block 502). For example, the computing device 100 may determine a plurality of correlation measures 312 for a plurality of audio data frames 302. In certain implementations, the plurality of audio data frames 302 may contain consecutive portions of audio data. In such instances, determining the plurality of correlation measures 312 may performed for each respective audio data frame 306 of at least a subset of the plurality of audio data frames 302.

The method 500 includes, when determining a respective correlation measure for a respective audio data frame, determining a first feature vector for the respective audio data frame (block 504). For example, the computing device 100 may determine a first feature vector 308 for the respective audio data frame 306. In certain implementations, the first feature vector 308 may include an MEL for the respective audio data frame 306, an MFCC for the respective audio data frame 306, a PCEN for the respective audio data frame 306, or a combination thereof.

The method 500 includes, when determining a respective correlation measure for a respective audio data frame, determining a respective correlation measure between the first feature vector and a second feature vector (block 506). For example, the computing device 100 may determine a respective correlation measure 314 between the first feature vector 308 and a second feature vector 310. In certain implementations, the second feature vector 310 may be determined for a second audio data frame 304 before the first portion of the audio data. In certain implementations, the respective audio data frame 306 may be the next consecutive audio data frame after the second audio data frame 304. In certain implementations, the respective correlation measure 314 may be determined as a cosine similarity between the first feature vector 308 and the second feature vector 310.

The method 500 includes, when determining a respective correlation measure for a respective audio data frame, adding the respective correlation measure to the plurality of correlation measures (block 508). For example, the computing device 100 may add the respective correlation measure 314 to the plurality of correlation measures 312. In certain implementations, the plurality of correlation measures 312 are stored in a circular buffer. In such instances, adding the respective correlation measure 314 may include removing an oldest correlation measure from the plurality of correlation measures 312. Blocks 504-508 may be repeated for each respective audio data frame 314 of at least a subset of the plurality of audio data frames 302 to determine the plurality of correlation measures 312 before proceeding to block 510. Additionally or alternatively, blocks 504-508 may be performed in response to receiving new audio data frame(s) on an ongoing basis to enable continuous monitoring for the spoken keyword 316.

The method 500 includes determining that the plurality of audio data frames contain a spoken keyword (block 510). For example, the computing device 100 may determine that the plurality of audio data frames 302 contain a spoken keyword 316. In certain implementations, determining that the audio data contains a spoken word may include providing the plurality of audio data frames 302 to a first model 318, the first model 318 may be configured to determine that the audio data contains a spoken keyword 316.

The method 500 includes determining a start time 326 for the spoken keyword within the audio data frames based at least in part on the plurality of correlation measures (block 512). For example, the computing device 100 may determine a start time 326 for the spoken keyword 316 within the audio data frames 302 based at least in part on the plurality of correlation measures 312. In certain implementations, determining the start time 326 for the spoken keyword 316 may include determining a change in the plurality of correlation measures 312 and determining a first estimate 332 of the start time 326 based on a time of the change. In certain implementations, the change may include a decrease between two or more sequential correlation measures 312 within the plurality of correlation measures 312.

The method 500 includes determining buffer data for the spoken keyword based on the start time for the spoken keyword (block 514). For example, the computing device 100 may determine buffer data 328 for the spoken keyword 316 based on the start time 326 for the spoken keyword 316. In certain implementations, the buffer data 328 may be used to verify detection of the spoken keyword 316. In certain implementations, the method 500 further includes providing the buffer data 328 to a second model 320, and the second model 320 may be configured to receive the buffer data 328 and determine whether the buffer data 328 contains the spoken keyword 316. In certain implementations, the first model 318 may be further configured to determine an end time 346 for the spoken keyword 316. In certain implementations, the buffer data 328 may include audio data captured between the start time 326 and the end time 346. In certain implementations, the buffer data 328 may further include one or more additional data frames captured before the start time 326 and one or more additional data frames captured after the end time 346.

In certain implementations, determining the start time 326 for the spoken keyword 316 may further include determining a first duration 338 based on the first estimate 332. For instance, the first duration 338 may be determined as the duration from the first estimate 332 of the start time 326 to a most recent audio data frame of the plurality of audio data frames 302. In such implementations, the method 500 may further include determining that the first duration 338 satisfies a threshold duration 330 and determining the start time 326 based on the first estimate 332 of the start time 326. In certain implementations, determining that the first duration 338 satisfies a threshold duration 330 may include determining that the first duration 338 is greater than or equal to the threshold duration (for e.g; 500 ms).

In certain implementations, determining the start time 326 for the spoken keyword 316 may further include determining a first duration 338 based on the first estimate 332, determining that the first duration 338 does not satisfy a threshold duration 330, and determining the start time 326 based on a predetermined duration for the spoken keyword 316.

In certain implementations, determining the start time 326 for the spoken keyword 316 may further include determining a background noise condition 344 for the audio data, determining that the background noise condition 344 satisfies a first condition, and determining the first estimate 332 of the start time 326 based on determining that the background noise condition 344 satisfies the first condition. In certain implementations, the background noise condition 344 for the audio data may be determined by a fourth machine learning model 324. In certain implementations, the first condition may be that the background noise condition 344 indicates ambient background noise within the audio data.

In certain implementations, determining the start time 326 for the spoken keyword 316 may further include determining, before determining the first estimate 332, a second estimate 334 with a model and determining a second duration 340 based on the second estimate 334. In certain implementations, the second duration 340 may be determined as the duration from the second estimate 334 of the start time 326 to a most recent audio data frame of the plurality of audio data frames 302.

In certain implementations, determining the start time 326 for the spoken keyword 316 may further include determining that the first duration 338 does not satisfy a threshold duration 330, and determining the background noise condition 344 for the audio data based on determining that the second duration 340 does not satisfy the threshold duration 330. In certain implementations, determining that the first duration 338 does not satisfy the threshold duration 330 may include determining that the first duration 338 is less than the threshold duration (for e.g; 500 ms).

In certain implementations, determining the start time 326 for the spoken keyword 316 may further include determining that the second duration 340 is greater than or equal to the first duration 338 and determining the start time 326 based on the second estimate 334. In certain implementations, determining the start time 326 for the spoken keyword 316 may further include determining that the second duration 340 is less than the first duration 338 and determining the start time 326 based on the first estimate 332. In certain implementations, determining the start time 326 for the spoken keyword 316 may further include determining a background noise condition 344 for the audio data, determining that the background noise condition 344 does not satisfy a first condition, determining a third estimate 336 of the start time 326 using a second model 320, and determining the start time 326 based on the third estimate 336.

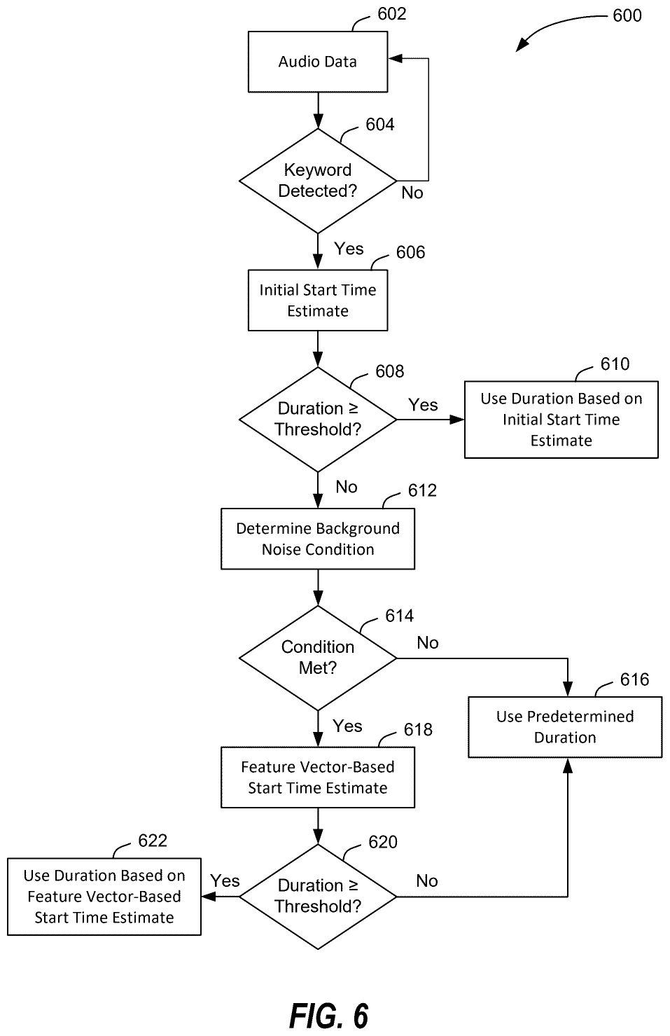

FIGS. 6-8 depict flow charts of additional methods 600, 700, 800 for accurately determining the start time and duration of a spoken keyword according to aspects of the present disclosure. Each of the operations described with reference to FIGS. 6-8 and the methods 600, 700, 800 may be performed by the computing device 100, such as one or a combination of processors of the computing device 100. In certain implementations, one or more of the operations of the methods 600, 700, 800 may be analogous, or exemplary implementations, of one or more operations of the system 300.

Starting with FIG. 6, the method 600 may be used to determine start times for spoken keywords based on background noise conditions. The method 600 may begin with receiving audio data (block 602), which may be analogous to the audio data and the plurality of audio data frames 302. The audio data may then be analyzed to determine whether the audio data contains a spoken keyword (block 604). For example, a model 318 may determine whether the audio data contains a spoken keyword. If the audio data does not contain a spoken keyword, the method 600 may repeat. If a spoken keyword is detected, an initial start time estimate of the keyword within the audio data is determined (block 606). For example, the model 318 may determine an estimate 334 of the start time 326 of the keyword. A duration of the spoken keyword may then be compared to a threshold (block 608). The duration may be determined based on the initial start time estimate. If the duration is greater than or equal to the threshold, the duration and the initial start estimate may be used for further processing (block 610). For example, the duration and/or the initial start time estimate may be used to determine buffer data for verification of the detected keyword). If the duration is not greater than or equal to the threshold, a background noise condition for the audio data may be determined (block 612). For example, a model 324, such as an ACD model, may be used to determine a background noise condition 344 based on the audio data. It may then be determined whether the background noise condition satisfies one or more conditions (block 614). For example, the background noise condition may be compared to a condition that specifies stationary or ambient background noise conditions. If the background noise condition does not satisfy the condition, a predetermined duration (such as 2 seconds) may be used for further processing (block 616). If the background noise condition does satisfy the condition, a feature vector-based start time estimate may be determined (block 618). For example, an estimate 332 of the start time 326 may be determined based on feature vectors 308, 310 and correlation measures 312 determined for audio data frames 302 of the audio data. A duration of the spoken keyword may then be compared to a threshold (block 620). The duration may be determined based on the feature vector-based start time estimate. If the duration is less than the threshold, the predetermined duration may be used for further processing (block 616). If the duration is greater than or equal to the threshold, the duration and/or the feature vector-based start time estimate may be used for further processing (block 622).

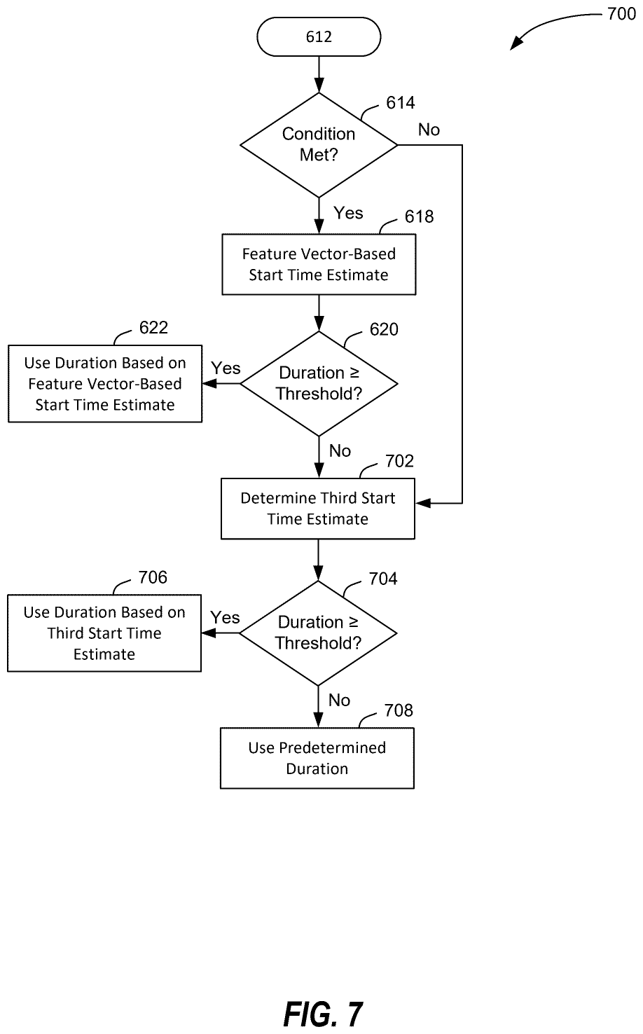

Turning to FIG. 7, the method 700 may be an alternative implementation to the method 600. In particular, the method 700 may perform blocks 602-614 and 618-622 similar to the method 600. However, if the duration based on the feature vector-based start time estimate is less than the threshold at block 620, the method 700 may proceed with determining a third start time estimate (block 702). Also, if the background noise condition does not satisfy the condition, the method 700 may proceed with determining the third start time estimate (block 702). The third start time estimate may be determined by a different model, such as a DNN VAD model. For example, a third estimate 336 of the start time 326 may be determined using the model 322. A duration may then be compared to the threshold (block 704). The duration may be determined based on the third start time estimate. If the duration is less than the threshold, a predetermined duration may be used for further processing of the audio data (block 708), which may be analogous to block 616 in the method 600. If the duration is greater than or equal to the threshold, the duration based on the third start time estimate may be used for further processing of the audio data (block 706).

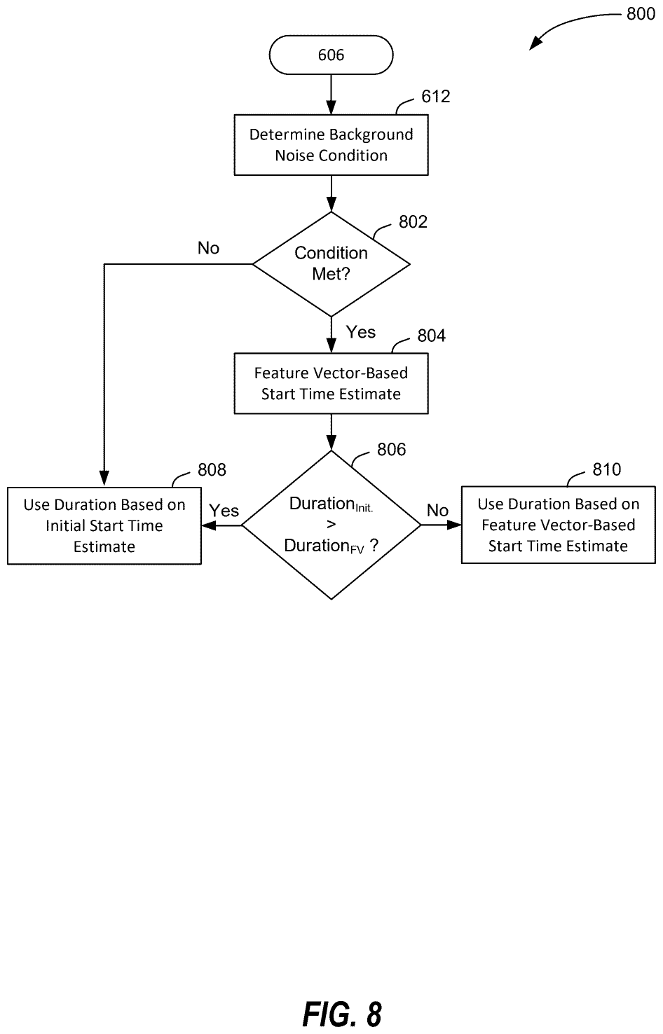

Turning to FIG. 8, the method 800 may perform blocks 602-606 similar to the method 600. However, the method 800 may proceed directly from determining the initial start time estimate at block 606 to determining the background noise condition at block 612 (such as without performing block 608). The background noise condition may then be compared to the condition (block 802), which may be analogous to block 614. If the condition is not met, a duration determined based on the initial start time estimate may be used for further processing (block 808), which may be analogous to block 610. If the condition is met, the feature vector-based start time estimate may be determined (block 804), which may be analogous to block 618. A duration determined based on the initial start estimate (Duration_{Init.}) may then be compared to a duration determined based on the feature vector-based estimate (Duration_{PV}). If Duration_{Init.} is greater than Duration_{FV}, Duration_{Init.} and/or the initial start time estimate may be used for further processing of the audio data (block 808), which may be analogous to block 610. If Duration_{Init.} is not greater than Duration_{FV}, Duration_{FV} and/or the feature vector-based start time estimate may be used for further processing of the audio data (block 810), which may be analogous to block 622.

In one or more aspects, techniques for supporting signal processing may include additional aspects, such as any single aspect or any combination of aspects described below or in connection with one or more other processes or devices described elsewhere herein.

A first aspect provides an apparatus, comprising a memory storing processor-readable code and one or more processors coupled to the memory. The one or more processors may be configured to execute the processor-readable code to cause the one or more processors to determine a plurality of correlation measures for a plurality of audio data frames, wherein the plurality of audio data frames contain consecutive portions of audio data. The one or more processors may be configured to execute the processor-readable code, when determining the plurality of correlation measures to, for each respective audio data frame of the plurality of audio data frames: determine a first feature vector for the respective audio data frame; determine a respective correlation measure between the first feature vector and a second feature vector, wherein the second feature vector is determined for a second audio data frame before the respective audio data frame; and add the respective correlation measure to the plurality of correlation measures. The one or more processors may also be configured to determine that the plurality of audio data frames contain a spoken keyword; determine a start time for the spoken keyword within the audio data frames based at least in part on the plurality of correlation measures; and determine buffer data for the spoken keyword based on the start time for the spoken keyword.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the one or more processors are configured to execute the processor-readable code, when determining that the audio data contains a spoken word, to provide the plurality of audio data frames to a first model. The first model is configured to determine that the audio data contains a spoken keyword.

In a third aspect, in combination with the second aspect, the one or more processors are further configured to execute the processor-readable code, to provide the buffer data to a second model. The second model is configured to receive the buffer data and determine whether the buffer data contains the spoken keyword.

In a fourth aspect, in combination with the third aspect, the first model is further configured to determine an end time for the spoken keyword.

In a fifth aspect, in combination with the fourth aspect, the buffer data comprises audio data captured between the start time and the end time.

In a sixth aspect, in combination with the fifth aspect, the buffer data further comprises one or more additional data frames captured before the start time.

In a seventh aspect, in combination with one or more of the first aspect through the sixth aspect, the one or more processors are configured to execute the processor-readable code, when determining the start time for the spoken keyword, to determine a change in the plurality of correlation measures; and determine a first estimate of the start time based on a time of the change.

In an eighth aspect, in combination with the seventh aspect, the change includes a decrease between two or more sequential correlation measures within the plurality of correlation measures.

In a ninth aspect, in combination with one or more of the seventh aspect through the eighth aspect, the one or more processors are configured to execute the processor-readable code, when determining the start time for the spoken keyword, to determine a first duration based on the first estimate; determine that the first duration satisfies a threshold duration; and determine the start time based on the first estimate of the start time.

In a tenth aspect, in combination with the ninth aspect, the first duration is determined as the duration from the first estimate of the start time to a most recent audio data frame of the plurality of audio data frames.

In an eleventh aspect, in combination with one or more of the ninth aspect through the tenth aspect, determining that the first duration satisfies a threshold duration comprises determining that the first duration is greater than or equal to 500 ms.

In a twelfth aspect, in combination with one or more of the ninth aspect through the eleventh aspect, the one or more processors are configured to execute the processor-readable code, when determining the start time for the spoken keyword, to determine a first duration based on the first estimate; determine that the first duration does not satisfy a threshold duration; and determine the start time based on a predetermined duration for the spoken keyword.

In a thirteenth aspect, in combination with one or more of the seventh aspect through the twelfth aspect, the one or more processors are configured to execute the processor-readable code, when determining the start time for the spoken keyword, to determine a background noise condition for the audio data; determine that the background noise condition satisfies a first condition; and determine the first estimate of the start time based on determining that the background noise condition satisfies the first condition.

In a fourteenth aspect, in combination with the thirteenth aspect, the first condition is that the background noise condition indicates stationary background noise within the audio data.

In a fifteenth aspect, in combination with one or more of the seventh aspect through the fourteenth aspect, the one or more processors are configured to execute the processor-readable code, when determining the start time for the spoken keyword, to determine, before determining the first estimate, a second estimate with a model; and determine a second duration based on the second estimate.

In a sixteenth aspect, in combination with the fifteenth aspect, the second duration is determined as the duration from the second estimate of the start time to a most recent audio data frame of the plurality of audio data frames.

In a seventeenth aspect, in combination with one or more of the fifteenth aspect through the sixteenth aspect, the one or more processors are configured to execute the processor-readable code, when determining the start time for the spoken keyword, to determine a first duration based on the first estimate; determine that the first duration does not satisfy a threshold duration; and determine a background noise condition for the audio data based on determining that the second duration does not satisfy the threshold duration.

In an eighteenth aspect, in combination with one or more of the fifteenth aspect through the seventeenth aspect, the one or more processors are configured to execute the processor-readable code, when determining the start time for the spoken keyword, to determine a first duration based on the first estimate; determine that the second duration is greater than or equal to the first duration; and determine the start time based on the second estimate.

In a nineteenth aspect, in combination with one or more of the fifteenth aspect through the eighteenth aspect, the one or more processors are configured to execute the processor-readable code, when determining the start time for the spoken keyword, to determine a first duration based on the first estimate; determine that the second duration is less than the first duration; and determine the start time based on the first estimate.

In a twentieth aspect, in combination with one or more of the first aspect through the nineteenth aspect, the one or more processors are configured to execute the processor-readable code, when determining the start time for the spoken keyword, to determine a background noise condition for the audio data; determine that the background noise condition does not satisfy a first condition; determine a third estimate of the start time using a second model; and determine the start time based on the third estimate.

In a twenty-first aspect, in combination with one or more of the first aspect through the twentieth aspect, the first feature vector includes a Mel-scaled spectral coefficient (MEL) for the respective audio data frame, a Mel-Frequency Cepstral Coefficient (MFCC) for the respective audio data frame, a Per-Channel Energy Normalization (PCEN) feature for the respective audio data frame, or a combination thereof.

In a twenty-second aspect, in combination with one or more of the first aspect through the twenty-first aspect, the respective audio data frame is a next consecutive audio data frame after the second audio data frame.

In a twenty-third aspect, in combination with one or more of the first aspect through the twenty-second aspect, the respective correlation measure is determined as a cosine similarity between the first feature vector and the second feature vector.

In a twenty-fourth aspect, in combination with one or more of the first aspect through the twenty-third aspect, the plurality of correlation measures are stored in a circular buffer, and the one or more processors are configured to execute the processor-readable code, when adding the respective correlation measure, to remove an oldest correlation measure from the plurality of correlation measures.

A twenty-fifth aspect provides a method, comprising determining a plurality of correlation measures for a plurality of audio data frames, wherein the plurality of audio data frames contain consecutive portions of audio data. Determining the plurality of correlation measures comprises, for each respective audio data frame of the plurality of audio data frames: determining a first feature vector for the respective audio data frame; determining a respective correlation measure between the first feature vector and a second feature vector, wherein the second feature vector is determined for a second audio data frame before the respective audio data frame; and adding the respective correlation measure to the plurality of correlation measures. The method also comprises determining that the plurality of audio data frames contain a spoken keyword; determining a start time for the spoken keyword within the audio data frames based at least in part on the plurality of correlation measures; and determining buffer data for the spoken keyword based on the start time for the spoken keyword.

In a twenty-sixth aspect, in combination with the twenty-fifth aspect, determining that the audio data contains a spoken word comprises providing the plurality of audio data frames to a first model. The first model is configured to determine that the audio data contains a spoken keyword.

In a twenty-seventh aspect, in combination with the twenty-sixth aspect, the method further comprises providing the buffer data to a second model. The second model is configured to receive the buffer data and determine whether the buffer data contains the spoken keyword.

In a twenty-eighth aspect, in combination with the twenty-seventh aspect, the first model is further configured to determine an end time for the spoken keyword.

In a twenty-ninth aspect, in combination with the twenty-eighth aspect, the buffer data comprises audio data captured between the start time and the end time.

In a thirtieth aspect, in combination with the twenty-ninth aspect, the buffer data further comprises one or more additional data frames captured before the start time.

In a thirty-first aspect, in combination with one or more of the twenty-fifth aspect through the thirtieth aspect, determining the start time for the spoken keyword comprises determining a change in the plurality of correlation measures; and determining a first estimate of the start time based on a time of the change.

In a thirty-second aspect, in combination with the thirty-first aspect, the change includes a decrease between two or more sequential correlation measures within the plurality of correlation measures.

In a thirty-third aspect, in combination with one or more of the thirty-first aspect through the thirty-second aspect, determining the start time for the spoken keyword further comprises determining a first duration based on the first estimate; determining that the first duration satisfies a threshold duration; and determining the start time based on the first estimate of the start time.

In a thirty-fourth aspect, in combination with the thirty-third aspect, the first duration is determined as the duration from the first estimate of the start time to a most recent audio data frame of the plurality of audio data frames.

In a thirty-fifth aspect, in combination with one or more of the thirty-third aspect through the thirty-fourth aspect, determining that the first duration satisfies a threshold duration comprises determining that the first duration is greater than or equal to 500 ms.

In a thirty-sixth aspect, in combination with one or more of the thirty-third aspect through the thirty-fifth aspect, determining the start time for the spoken keyword further comprises determining a first duration based on the first estimate; determining that the first duration does not satisfy a threshold duration; and determining the start time based on a predetermined duration for the spoken keyword.

In a thirty-seventh aspect, in combination with one or more of the thirty-first aspect through the thirty-sixth aspect, determining the start time for the spoken keyword further comprises determining a background noise condition for the audio data; determining that the background noise condition satisfies a first condition; and determining the first estimate of the start time based on determining that the background noise condition satisfies the first condition.

In a thirty-eighth aspect, in combination with the thirty-seventh aspect, the first condition is that the background noise condition indicates ambient background noise within the audio data.

In a thirty-ninth aspect, in combination with one or more of the thirty-first aspect through the thirty-eighth aspect, determining the start time for the spoken keyword further comprises determining, before determining the first estimate, a second estimate with a model; and determining a second duration based on the second estimate.

In a fortieth aspect, in combination with the thirty-ninth aspect, the second duration is determined as the duration from the second estimate of the start time to a most recent audio data frame of the plurality of audio data frames.

In a forty-first aspect, in combination with one or more of the thirty-ninth aspect through the fortieth aspect, determining the start time for the spoken keyword further comprises determining a first duration based on the first estimate; determining that the first duration does not satisfy a threshold duration; and determining a background noise condition for the audio data based on determining that the second duration does not satisfy the threshold duration.

In a forty-second aspect, in combination with one or more of the thirty-ninth aspect through the forty-first aspect, determining the start time for the spoken keyword further comprises determining a first duration based on the first estimate; determining that the second duration is greater than or equal to the first duration; and determining the start time based on the second estimate.

In a forty-third aspect, in combination with one or more of the thirty-ninth aspect through the forty-second aspect, determining the start time for the spoken keyword further comprises determining a first duration based on the first estimate; determining that the second duration is less than the first duration; and determining the start time based on the first estimate.

In a forty-fourth aspect, in combination with one or more of the twenty-fifth aspect through the forty-third aspect, determining the start time for the spoken keyword further comprises determining a background noise condition for the audio data; determining that the background noise condition does not satisfy a first condition; determining a third estimate of the start time using a second model; and determining the start time based on the third estimate.

In a forty-fifth aspect, in combination with one or more of the twenty-fifth aspect through the forty-fourth aspect, the first feature vector includes a Mel-scaled spectral coefficient (MEL) for the respective audio data frame, a Mel-Frequency Cepstral Coefficient (MFCC) for the respective audio data frame, a Per-Channel Energy Normalization (PCEN) feature for the respective audio data frame, or a combination thereof.

In a forty-sixth aspect, in combination with one or more of the twenty-fifth aspect through the forty-fifth aspect, the respective audio data frame is a next consecutive audio data frame after the second audio data frame.

In a forty-seventh aspect, in combination with one or more of the twenty-fifth aspect through the forty-sixth aspect, the respective correlation measure is determined as a cosine similarity between the first feature vector and the second feature vector.

A forty-eighth aspect provides a non-transitory computer-readable medium storing instructions that, when executed by at least one processor, cause the at least one processor to determine a plurality of correlation measures for a plurality of audio data frames, wherein the plurality of audio data frames contain consecutive portions of audio data. When determining the plurality of correlation measures, the one or more processors are configured to execute the instructions, for each respective audio data frame of the plurality of audio data frames, to determine a first feature vector for the respective audio data frame; determine a respective correlation measure between the first feature vector and a second feature vector, wherein the second feature vector is determined for a second audio data frame before the respective audio data frame; and add the respective correlation measure to the plurality of correlation measures. The at least one processor is also caused to determine that the plurality of audio data frames contain a spoken keyword; determine a start time for the spoken keyword within the audio data frames based at least in part on the plurality of correlation measures; and determine buffer data for the spoken keyword based on the start time for the spoken keyword.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 5-8 may be combined with one or more blocks (or operations) described with reference to another of the figures. For example, one or more blocks (or operations) of FIG. 5 may be combined with one or more blocks (or operations) of FIG. 1 or FIG. 3. As another example, one or more blocks associated with FIG. 5 may be combined with one or more blocks (or operations) associated with FIG. 6, 7, or 8.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc wherein disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus, comprising:
a memory configured to store a spoken keyword; and
one or more processors coupled to the memory, the one or more processors configured to:
determine a first feature vector for a respective audio data frame;
determine a respective correlation measure between the first feature vector and a second feature vector, wherein the second feature vector is determined for a second audio data frame before the respective audio data frame; and
add the respective correlation measure to one or more prior correlation measures, to update a plurality of correlation measures;
determine that a plurality of audio data frames contain the spoken keyword;
determine a start time for the spoken keyword within at least the respective audio data frame, and the second audio data frame based at least in part on the respective correlation measure and the one or more prior correlation measures; and
determine buffer data for the spoken keyword based on the start time for the spoken keyword.

2. The apparatus of claim 1, wherein the one or more processors are configured to provide the respective audio data frame and the second audio data frame to a first model, wherein the first model is configured to determine that the audio data contains a spoken keyword.

3. The apparatus of claim 2, the one or more processors are configured to provide the buffer data to a second model, wherein the second model is configured to receive the buffer data and determine whether the buffer data contains the spoken keyword.

4. The apparatus of claim 3, wherein the first model is configured to determine an end time for the spoken keyword, and wherein the buffer data comprises audio data captured between the start time and the end time.

5. The apparatus of claim 4, wherein the buffer data further comprises one or more additional data frames captured before the start time.

6. The apparatus of claim 1, wherein the one or more processors are to:
determine a change in the updated plurality of correlation measures; and
determine a first estimate of the start time based on a time of the change.

7. The apparatus of claim 6, wherein the change includes a decrease between two or more sequential correlation measures within the updated plurality of correlation measures.

8. The apparatus of claim 6, wherein the one or more processors are configured, to:
determine a first duration based on the first estimate;
determine that the first duration satisfies a threshold duration; and
determine the start time based on the first estimate of the start time.

9. The apparatus of claim 8, wherein the one or more processors are configured to:
determine a first duration based on the first estimate;
determine that the first duration does not satisfy a threshold duration; and
determine the start time based on a predetermined duration for the spoken keyword.

10. The apparatus of claim 6, wherein the one or more processors are configured to:
determine a background noise condition for the audio data;
determine that the background noise condition satisfies a first condition; and
determine the first estimate of the start time based on determining that the background noise condition satisfies the first condition.

11. The apparatus of claim 10, wherein the first condition is that the background noise condition indicates stationary background noise within the audio data.

12. The apparatus of claim 6, wherein the one or more processors are configured to:
determine, before determining the first estimate, a second estimate with a model; and
determine a second duration based on the second estimate.

13. The apparatus of claim 12, wherein the one or more processors are configured to:
determine a first duration based on the first estimate;
determine that the first duration does not satisfy a threshold duration; and
determine a background noise condition for the audio data based on that the second duration does not satisfy the threshold duration.

14. The apparatus of claim 12, wherein the one or more processors are configured to:
determine a first duration based on the first estimate;
determine that the second duration is greater than or equal to the first duration; and
determine the start time based on the second estimate.

15. The apparatus of claim 12, wherein the one or more processors are configured, to:
determine a first duration based on the first estimate;
determine that the second duration is less than the first duration; and
determine the start time based on the first estimate.

16. The apparatus of claim 1, wherein the one or more processors are configured to to:
determine a background noise condition for the audio data;
determine that the background noise condition does not satisfy a first condition;
determine a third estimate of the start time using a second model; and
determine the start time based on the third estimate.

17. The apparatus of claim 1, wherein the respective audio data frame is a next consecutive audio data frame after the second audio data frame.

18. The apparatus of claim 1, the updated plurality of correlation measures are stored in a circular buffer, and wherein the one or more processors are configured to remove an oldest correlation measure from the updated plurality of correlation measures.

19. A method, comprising:
determine a first feature vector for a respective audio data frame;
determine a respective correlation measure between the first feature vector and a second feature vector, wherein the second feature vector is determined for a second audio data frame before the respective audio data frame; and
add the respective correlation measure to one or more prior correlation measures, to update a plurality of correlation measures;
determine that a plurality of audio data frames contain the spoken keyword;
determine a start time for a spoken keyword within at least the respective audio data frame, and the second audio data frame based at least in part on the respective correlation measure and the one or more prior correlation measures; and
determine buffer data for the spoken keyword based on the start time for the spoken keyword.

20. A non-transitory computer-readable medium storing instructions that, when executed by at least one processor, cause the at least one processor to:
determine a first feature vector for a respective audio data frame;
determine a respective correlation measure between the first feature vector and a second feature vector, wherein the second feature vector is determined for a second audio data frame before the respective audio data frame; and
add the respective correlation measure to one or more prior correlation measures, to update a plurality of correlation measures;
determine that a plurality of audio data frames contain the spoken keyword;
determine a start time for a spoken keyword within at least the respective audio data frame, and the second audio data frame based at least in part on the respective correlation measure and the one or more prior correlation measures; and
determine buffer data for the spoken keyword based on the start time for the spoken keyword.
